(19) United States
(12) Patent Application Publication
(10) Pub. No.: US 2021/0331414 A1
(43) Pub. Date: Oct. 28, 2021

(54) DETERMINING MELTING POINT OF BUILD MATERIAL

(71) Applicant: HEWLETT-PACKARD DEVELOPMENT COMPANY, L.P., Spring, TX (US)

(72) Inventors: Luis Garcia Garcia, Sant Cugat del Valles (ES); Alejandro Manuel de Pena Hempel, Sant Cugat del Valles (ES); Ismael Fernandez Aymerich, Sant Cugat del Valles (ES)

(21) Appl. No.: 16/608,248

(22) PCT Filed: Jul. 26, 2018
(86) PCT No.: PCT/US2018/043900

§ 371 Date: Oct. 25, 2019

(51) Int. Cl. B29C 64/393; B29C 64/153; B33Y 10/00; B33Y 30/00; B33Y 50/02

(52) U.S. Cl. CPC B29C 64/393; B29C 64/153; B29K 2077/00; B33Y 30/00; B33Y 50/02; B33Y 10/00

(57) ABSTRACT

In an example, an additive manufacturing device comprises a sensor, a moveable radiation source and a controller. The controller may determine an output of the sensor at a point at which build material melts by causing the moveable radiation source to periodically move over a layer of the build material to provide radiation to the layer of build material and monitoring the output of the sensor.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a simplified schematic of an example of an additive manufacturing device;

FIG. 2 is a flow chart of an example of a method of determining a melting point of build material;

FIG. 3 is a flow chart of an example of a method of determining a melting point of build material; and

FIG. 4 is a simplified schematic of an example of an additive manufacturing apparatus.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material to which fusing agent has been applied heats up/melts, coalesces and solidifies to form a slice of the three-dimensional object in accordance with the pattern. In other examples, coalescence may be achieved in some other manner.

In an example, a suitable fusing agent may be an ink-type formulation comprising carbon black, such as, for example, the fusing agent formulation commercially known as V1Q60A “HP fusing agent” available from HP Inc. In some examples, a fusing agent may comprise at least one of an infra-red light absorber, a near infra-red light absorber, a visible light absorber and a UV light absorber. Examples of print agents comprising visible light enhancers are dye based colored ink and pigment based colored ink, such as inks commercially known as CE039A and CE042A available from HP Inc.

In addition to a fusing agent, in some examples, a print agent may comprise a detailing agent, or coalescence modifier agent, which acts to modify the effects of a fusing agent for example by reducing (e.g. by cooling) or increasing coalescence or to assist in producing a particular finish or appearance to an object. Detailing agent may also be used to control thermal aspects of a layer of build material—e.g. to provide cooling. In some examples, detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a coalescence modifier agent, and/or as a print agent to provide a particular color for the object. Print agents may control or influence other physical or appearance properties, such as strength, resilience, conductivity, transparency, surface texture or the like.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices defined between parallel planes of the model. Each slice may define a portion of a respective layer of build material that is to be solidified or caused to coalesce by the additive manufacturing system.

In some examples, prior to generating objects, apparatus may undergo calibration and/or checking of the apparatus (where calibration in the context may comprise finding the measured temperature which corresponds to the melting temperature of the build material, given any or any combination of variability in temperature sensors, build material types and batches, apparatus condition, environmental conditions and the like).

In some examples of such calibration/checking exercises, a portion of a layer or a few successive layers of build material towards the bottom of a fabrication chamber are caused to melt, fuse, or otherwise coalesce, by the addition of fusing agent and the subsequent application of heat. A ‘blank’ layer (i.e. without fusing agent) of build material is formed on top of this fused patch and heat is applied until the blank layer melts above the fused patch. By leaving a layer of the build material blank, melting occurs relatively slowly, allowing a change in gradient of temperature associated with melting to be readily identified. The exercise may serve to calibrate the heat control set points and as a warning of a fault in the apparatus (for example, if temperature does not increase as anticipated, a heat lamp may not be operating correctly), and the rest of a build operation may be abandoned if a fault is detected.

In some examples, a calibration/checking exercise may involve monitoring the temperature of a region of a layer of build material or a surface of a layer of build material over time. The melting point of the build material may be identified as an inflection on a temperature gradient over time graph. As the temperature of a region of build material may remain relatively stable while undergoing a phase change from solid to liquid, an increase in temperature (or a faster increase) may indicate that the region of build material has fully melted and is therefore indicative of the melting temperature (or more particularly in some contexts, the melting temperature as measured by that thermal sensing apparatus).

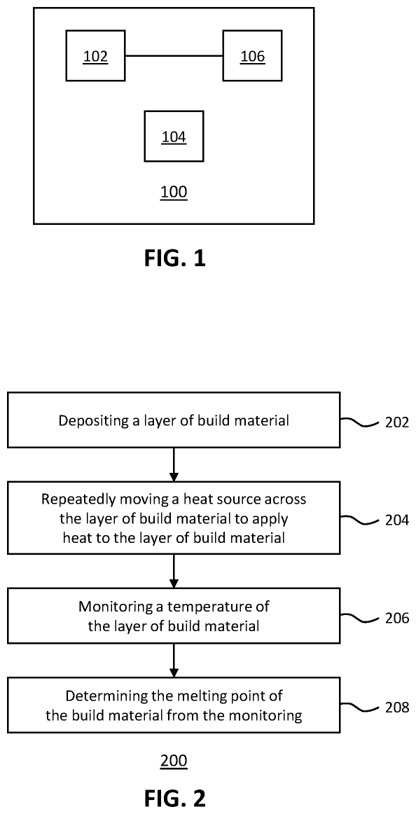

FIG. 1 is a simplified schematic of an example of an additive manufacturing device 100. The additive manufacturing device 100 comprises a sensor 102. For example, the sensor 102 is to sense a property of the layer of build material, such as the temperature of one or more points or regions of a layer of build material or a surface of a layer of build material. In some examples, the sensor 102 may provide an output from which the temperature of a portion of a layer of build material, or a surface of a layer of build material, can be determined or derived. The layer of build material may in some examples be held within the device 100, such as for example within a build chamber.

The device 100 also comprises a moveable radiation source 104. In some examples, the moveable radiation source 104 applies heat substantially to a region of build material proximate to or underneath the moveable radiation source 104. The region may be a region which is less than the whole layer, i.e. a sub-portion of the layer. Thus, the radiation source 104 may, in some examples, be moveable such that heat can be applied to various regions of a layer of build material, such as for example a portion or all of a layer of build material. In some examples, the moveable radiation source 104 may be scanned or passed over a layer, in some examples, substantially all of a layer, heating each region thereof in turn. In some examples, there may be multiple such scanning operations over a layer.

The device 100 further includes a controller 106 to determine an output of the sensor at a point at which build material melts by causing the moveable radiation source 104 to periodically move over a layer of the build material to provide radiation to the layer of build material and monitoring the output of the sensor. For example, the moveable radiation source 104 may make passes over the layer of build material (e.g. in response to control or a command from the controller 106) which heats at least a portion of build material that is being monitored by the sensor 102. The response over time of the build material to heating by the moveable radiation source, for example as measured by the sensor 102 while the moveable radiation source 104 moves over the layer of build material in multiple scanning operations/passes, may in some examples be used to determine the point at which the build material melts, e.g. the value output of the sensor at the melting point. In some examples, causing the moveable radiation source 104 to periodically move over the layer of build material may involve moving the moveable radiation source 104 in a regular fashion, or in other examples in an irregular fashion.

In some examples, therefore, the additive manufacturing device 100 or the controller 106 may determine the sensor reading when the build material has just melted, and may use this in a subsequent additive manufacturing process. This may serve to calibrate the heat control set points, in some examples for use in forming an object in an additive manufacturing process. In some examples, such a calibration may be carried out for an additive manufacturing process which is to be carried out directly thereafter, for example by forming at least one subsequent layer on top of the layers used for calibration, and causing a portion of the subsequent layer(s) to coalesce to form intended three dimensional object(s). For example, the information may be used to ensure that a sufficient level of radiation or heat is applied to layers of build material during the additive manufacturing process to ensure that portions of build material intended to form parts of solid objects have melted, and/or to ensure that surrounding areas of build material that should not form parts of solid objects do not melt. This may allow variations in, for example, build material (resulting in different melting points) and/or changes in sensor sensitivity to be taken into account in additive manufacturing processes.

In some examples, the sensor 102 may output a signal from which the temperature can be derived. In some examples, the sensor 102 may output the temperature. In some examples, the sensor 102 may output signals from which the temperature of multiple portions of the layer of build material can be derived, signals indicating the temperature of multiple portions of the layer of build material, and/or signals indicating a combination (e.g. average) of temperatures from multiple portions. The portions may be for example pixels in a thermal image of the layer of build material. In such cases, the sensor 102 may be for example a thermal camera.

In some examples, the sensor 102 is to provide an indication of the temperature of a surface of a portion of the layer of build material. Additionally, or alternatively, in some examples, the moveable radiation source 104 is moveable between the sensor and the portion of the layer of build material. This may for example be the case if the sensor 102 is positioned so as to have a field of view which covers substantially the whole of a layer of build material. For example, the sensor 102 may comprise a thermal imaging camera, which comprises a thermal image or ‘heat map’ of the layer. This may set a minimum practical distance between the sensor 102 and the layer of build material. However, it may be intended that the moveable radiation source 104, which is to be moved or scanned over the surface of the layer, is relatively close thereto, to provide for efficient and/or directed heat transfer. The moveable radiation source 104 may therefore in some examples cause the output of the sensor 102 to change when the moveable radiation source 104 moves between the sensor 102 and the layer of build material. For example, the output of the sensor 102 or determined from the sensor output may drop if the output drops with a fall in temperature of an object placed in a sensor's field of view. In one example, a temperature decrease may be detected when the moveable radiation source 104 is between the sensor 102 and the layer, as the temperature of moveable radiation source 104 may be lower than that of the layer. In some examples, the temperature decrease may be seen in a pixel of a heat map, or any other location of the layer. Thus, in some examples, the controller may take the drop or drops (or other changes) in sensor output into account when determining the melting temperature of the build material. For example, the envelope of a signal from the sensor 102, or an envelope of the temperature over time, may be used to determine the melting temperature. For example, it may be the case that the moveable radiation source 104 passes over a layer multiple times before the melting point is reached. In such examples, while a signal sensed by the sensor 102 may fluctuate as the moveable radiation source 104 passes between the sensor 102 and the layer, the envelope of the sensor signal (which may be an upper envelope associated with higher detected temperatures) may show a ‘pre-melting’ thermal behaviour, ‘melting’ thermal behaviour (during which the temperature is likely to be relatively stable) and a ‘post melting’ thermal behaviour. In both the pre-melting and post-melting stages, the temperature of the layer may increase at a faster rate that during melting. The envelope may therefore be used to, in effect, filter the effect of the moving radiation source 104 from the signal of the sensor 102.

In some examples, the controller 106 is to cause a region of build material underneath the portion of build material to fuse to form a solid object. In some examples, the solid object underneath the layer of build material (which may itself be a blank layer of build material, i.e. untreated with fusing agent) may cause the build material above the solid object to heat up more quickly than the rest of the layer of build material. This may in some examples allow the area that undergoes the quickest heating to be controlled. For example, the sensor may sense a particular point or points on the layer of build material, and the fused portion may be formed underneath the particular point or points.

In some examples, the sensor 102 may be moveable, such as for example mounted on the moveable heat source 104 or mounted on the same carriage as the moveable heat source. In such examples, the moveable heat source 104 may not move between the sensor 102 and the layer of build material. However, in some examples the output of the sensor 102 may change cyclically or periodically as the sensor 102 moves across the layer of build material. For example, where there is a region of fused build material underneath the portion of build material forming a solid object, the output of the sensor 102 may indicate a temperature increase as it moves over the solid object, and indicate a lower temperature as the sensor senses other parts of the layer of build material. In some examples, processing of the sensor output or a temperature derived therefrom, such as for example low pass or envelope filtering, may be used to determine the sensor output at the point at which the build material melts.

In some examples, the controller 106 is to determine the output of the sensor 102 at the point at which the build material melts by determining a plurality of temperatures of a surface of the layer of build material from the output of the sensor 102 and determining the output of the sensor 102 at the point at which the build material melts from the plurality of temperatures. The plurality of temperatures may in some examples be determined over time, such that the behaviour over time of the build material as it is heated by the moveable radiation source 104 can be monitored. In some examples, the controller 106 is to determine the output of the sensor 102 at the point at which the build material melts by determining an envelope of the output of the sensor 102 or a temperature derived therefrom (e.g. an envelope of the plurality of temperatures), and determining the output of the sensor 102 at the point at which the build material melts from the envelope. Alternatively a low pass filtered or moving average value of the sensor output or the temperature may be used in some examples. Therefore, for example, variation in the output of the sensor can in some examples be taken into account. In some examples, the moveable radiation source 104 may periodically move between the sensor 102 and the build material being monitored, causing the sensor output to periodically change, e.g. periodically drop. Therefore, for example, the envelope (or other waveform such as low pass filtered or moving average) of the sensor output or the temperature may indicate the temperature of the build material over time, substantially excluding the effects of the periodic blocking of the sensor 102 by the moveable radiation source 104. The output of the sensor 102 at the point at which build the material melts may then be determined therefrom.

In some examples, the moveable radiation source 104 comprises a fusing heat source to cause portions of build material to fuse in an additive manufacturing process. Therefore, for example, the same lamp can be used in the process for determining the output of the sensor at the point at which the build material melts as is used in the additive manufacturing process to heat, melt and thus fuse build material to form solid objects. In alternative examples, a separate moveable radiation source may be used.

FIG. 2 is a flow chart of an example of a method 200 of determining a melting point of build material. The method 200 may in some examples be carried out by an additive manufacturing apparatus or 3D printing device. The method 200 comprises, in block 202, depositing a layer of build material. The layer of build material may be deposited, in some examples, over another layer of build material in which a solid object has been previously formed. The layer of build material may be deposited in some examples within a build chamber.

Block 204 of the method 200 comprises repeatedly moving a heat source across the layer of build material to apply heat to the layer of build material. The heat source may be a fusing heat source in some examples, or alternatively may be a different moveable heat source.

Block 206 of the method 200 comprises monitoring a temperature of the layer of build material. For example, a temperature sensor or a thermal imaging camera may be used to monitor the temperature. Block 208 of the method 200 comprises determining the melting point of the build material from the monitoring. For example, an inflection point of the monitored temperature may occur at the point at which most or all of a region or portion the build material has melted.

In some examples, moving a heat source across the layer of build material comprises moving the heat source between a temperature sensor and the layer of build material, and wherein monitoring the temperature of the layer of build material comprises monitoring the temperature based on the sensor, e.g. based on an output from the sensor. In some examples, the movement of the heat source between the sensor and the layer of build material may cause the output of the sensor (e.g. an indicated temperature) to periodically change, such as drop for example. The sensor output or a temperature derived therefrom may in some examples be processed over time to account for such periodic changes. For example, the envelope, moving average or low-pass filtered values may be used to determine the melting point of the build material.

In some examples, monitoring the temperature of the layer of build material comprises monitoring the temperature of the surface of a portion of the layer of build material.

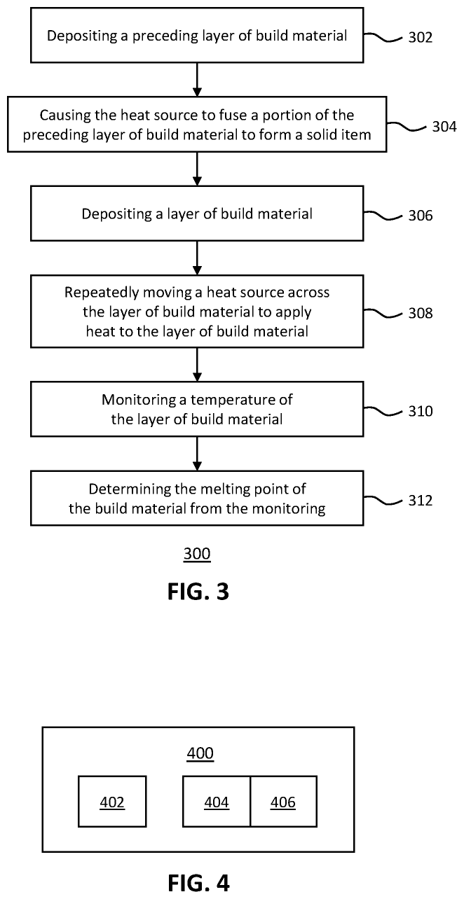

FIG. 3 is a flow chart of an example of a method 300 of determining a melting point of build material. The method 300 comprises, in block 302, depositing a preceding layer of build material. The preceding layer of build material precedes (i.e. is deposited before) the layer deposited in block 306, described below. The method 300 also comprises, in block 304, causing the heat source to fuse a portion of the preceding layer of build material to form a solid item.

The method 300 also comprises, in block 306, depositing a layer of build material, and in block 308, repeatedly moving a heat source across the layer of build material to apply heat to the layer of build material. The method 300 also comprises, in block 310, monitoring a temperature of the layer of build material, and in block 312, determining the melting point of the build material from the monitoring. In some examples, one or more of blocks 306-312 of the method 300 may be similar or identical to blocks 202-208 respectively of the method 200 described above with respect to FIG. 2. In some examples, monitoring the temperature of the layer of build material in block 310 comprises monitoring the temperature of a portion of the layer of build material overlying the solid item. In some examples, the layer of build material deposited in block 306 is a ‘blank’ layer, to which fusing agent is not applied, whereas fusing agent may be applied to the preceding layer, i.e. the layer deposited in block 302 and caused to fuse in block 304. In some examples, there may be at least one blank layer between the layer deposited in block 302 and the layer deposited in block 306.

FIG. 4 is a simplified schematic of an example of an additive manufacturing apparatus 400. The apparatus 400 comprises a temperature sensor 402 to monitor a temperature of a portion of a layer of build material, and a heater 404 to apply heat to a selected region of the layer of build material. The selected region may be for example a region of build material underneath or proximate the heater, and may be selected by positioning the heater.

The apparatus 400 also comprises a carriage 406 to carry the heater 404 (e.g. to select a region of build material for heating) and to periodically move the heater across the layer of build material to apply heat to the layer of build material during a measurement process. The additive manufacturing apparatus 400 is to calculate a temperature measurement from the temperature sensor at a melting point of the build material during the measurement process from the temperature of the portion of the layer of build material. For example, the additive manufacturing apparatus, while the heater 404 is periodically moved across the layer of build material to apply heat thereto, observes the output of the sensor 402 to determine when the build material (e.g. at least a portion thereof) melts, and thus determines a temperature reading or other output from the sensor 402 at that point. Determining when the build material melts may comprise for example determining that the temperature of the build material being observed undergoes an increase, more rapid increase, or an inflection point. In some examples, periodically moving the heater over the layer of build material comprises moving the heater in a regular, repeating pattern, though in other examples the heater may be moved in an irregular fashion. In some examples, periodically moving the heater over the layer of build material comprises moving the heater over the layer of build material in with a plurality of heating passes.

In some examples, the carriage 406 is to periodically move the heater 404 between the temperature sensor 402 and the layer of build material during the measurement process. An output of the sensor 402, and/or a temperature measurement derived therefrom, may in some examples be processed over time to account for this movement and blocking. For example, the heater 404 may move over a layer in a plurality of passes before the melting temperature is reached. For example, the values may be low pass filtered, or an envelope (which may be an upper envelope) or moving average may be determined and used to determine when the build material melts. For example, the additive manufacturing apparatus 400 is to calculate the temperature measurement from an envelope of the temperature of the portion of the layer of build material.

Examples in the present disclosure can be provided as methods, systems or machine-readable instructions, such as any combination of software, hardware, firmware or the like. Such machine-readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. An additive manufacturing device comprising:
a sensor;
a moveable radiation source; and
a controller to determine an output of the sensor at a point at which build material melts by causing the moveable radiation source to periodically move over a layer of build material to provide radiation to the layer of build material and monitoring the output of the sensor.

2. The additive manufacturing device of claim 1, wherein the sensor is to sense a property of the layer of build material.

3. The additive manufacturing device of claim 1, wherein the sensor is to provide an indication of temperature of a surface of a portion of the layer of build material, wherein the moveable radiation source is moveable between the sensor and the portion of the layer of build material.

4. The additive manufacturing device of claim 3, wherein the controller is to cause a region of build material underneath the portion of the layer of build material to fuse to form a solid object.

5. The additive manufacturing apparatus of claim 1, wherein the controller is to determine the output of the sensor at the point at which the build material melts by determining a plurality of temperatures of a surface of the layer of build material from the output of the sensor and determining the output of the sensor at the point at which the build material melts from the plurality of temperatures.

6. The additive manufacturing apparatus of claim 5, wherein the controller is to determine the output of the sensor at the point at which the build material melts by determining an envelope of the plurality of temperatures and determining the output of the sensor at the point at which the build material melts from the envelope.

7. The additive manufacturing apparatus of claim 1, wherein the moveable radiation source comprises a fusing heat source to cause portions of build material to fuse in an additive manufacturing process.

8. The additive manufacturing apparatus of claim 1, wherein the moveable radiation source is moveable between the sensor and the layer of build material.

9. A method of determining a melting point of build material, comprising:
depositing a layer of build material;
repeatedly moving a heat source across the layer of build material to apply heat to the layer of build material;
monitoring a temperature of the layer of build material; and
determining the melting point of the build material from the monitoring.

10. The method of claim 9, wherein moving a heat source across the layer of build material comprises moving the heat source between a temperature sensor and the layer of build material, and wherein monitoring the temperature of the layer of build material comprises monitoring the temperature based on the temperature sensor.

11. The method of claim 9, wherein monitoring the temperature of the layer of build material comprises monitoring the temperature of a surface of a portion of the layer of build material.

12. The method of claim 9, comprising, prior to depositing the layer of build material, depositing a preceding layer of build material, and causing the heat source to fuse a portion of the preceding layer of build material to form a solid item; and wherein monitoring the temperature of the layer of build material comprises monitoring the temperature of a portion of the layer of build material overlying the solid item.

13. An additive manufacturing apparatus comprising:
a temperature sensor to monitor a temperature of a portion of a layer of build material;
a heater to apply heat to a selected region of the layer of build material; and
a carriage to carry the heater and to periodically move the heater across the layer of build material to apply heat to the layer of build material during a measurement process;
wherein the additive manufacturing apparatus is to calculate a temperature measurement from the temperature sensor at a melting point of the build material during the measurement process from the temperature of the portion of the layer of build material.

14. The apparatus of claim 13, wherein the carriage is to periodically move the heater between the temperature sensor and the layer of build material during the measurement process.

15. The apparatus of claim 13, wherein the additive manufacturing apparatus is to calculate the temperature measurement from an envelope of the temperature of the portion of the layer of build material.
